(19) United States
(12) Patent Application Publication
(10) Pub. No.: US 2003/0075173 A1
(43) Pub. Date: Apr. 24, 2003

(54) Inhalation protection apparatuses

(76) Inventor: Daniel Shahaf, Zichron Yaakov (IL)

Correspondence Address: BAKER & MCKENZIE, 805 THIRD AVENUE, NEW YORK, NY, 10022, US

(21) Appl. No.: 10/051,712

(22) Filed: Jan. 17, 2002

Related U.S. Application Data
(60) Provisional application No. 60/345,074, filed on Oct. 24, 2001.

(51) Int. Cl. A62B 7/10

(52) U.S. Cl. 128/201.25

(57) ABSTRACT

Breathing apparatuses for protecting users from inhaling contaminated air through their mouth and nose. One of the exemplary breathing apparatuses utilizes a filtering unit, whereas another exemplary breathing apparatus utilizes a air source in conjunction with a filtering unit. A nose plug prevents the contaminated air from entering the users' nose and a transparent bag prevents the contaminated air from entering the eyes, ears and noses of the users.

### CROSS-REFERENCE TO RELATED APPLICATIONS

The present application claims benefit of provisional application No. 60/345,074 filed Oct. 24, 2001.

### FIELD

The present application relates to inhalation protection apparatuses and, more particularly, to breathing apparatuses that protect a user of the respective apparatus from inhaling contaminated air.

### BACKGROUND OF THE INVENTION

Respirators, also known as gas masks, are an important part of safety. For instance, respirators protect people from flour dust in a grain elevator and damaging organic chemicals in paint spray. Moreover, respirators are useful to counter terrorist acts using chemical weapons and/or biological weapons.

Filters used with respirators can remove poisonous chemicals and deadly bacteria from the air. A typical disposable filter cartridge for a respirator operates as follows. When a user inhales, air flows through the inlet, through a particulate filter, through an activated charcoal filter, through another particulate filter (to trap charcoal dust) and through an outlet into the mask. When the particulate filter clogs or the activated charcoal becomes saturated, the cartridge needs to be replaced.

An air filter can use one or more of three different techniques to purify air. These techniques include particle filtration, chemical absorption or adsorption and chemical reaction to neutralize a chemical.

Particle filtration is the simplest of the three. In a gas mask designed to guard against a biological threat, a very fine particulate filter can be used. An anthrax bacteria or spore might have a minimum size of one micron. Most biological particulate filters remove particle sizes as small as 0.3 microns. Any particulate filter eventually clogs, so it has to be replaced as breathing becomes difficult.

A chemical threat needs a different approach because chemicals come as mists or vapors that are largely immune to particulate filtration. The most common approach with any organic chemical is activated charcoal which is a carbon. Activated charcoal is charcoal that has been treated with oxygen to open up millions of tiny pores between the carbon atoms. The use of special manufacturing techniques results in highly porous charcoals that have surface areas of 300-2,000 square meters per gram. These activated charcoals are widely used to adsorb odorous or colored substances from gases or liquids. When a material adsorbs something, the material attaches to it by chemical attraction. The large surface area of activated charcoal gives it countless bonding sites. When certain chemicals pass next to the carbon surface, the chemicals attach to the surface and are trapped. Activated charcoal is effective at trapping carbon-based impurities, such as organic chemicals, as well as things like chlorine. Many other chemicals are not attracted to carbon at all, for instance, sodium and nitrates, so these chemicals pass right through. Thus, an activated-charcoal filter will remove certain impurities while ignoring others and once all of the bonding sites are filled, an activated-charcoal filter stops working. At that point, the filter needs to be replaced. Activated charcoal can be treated with other chemicals to improve its adsorption abilities for a specific toxin.

The third technique involves chemical reactions. Respirators can contain chemicals designed to react with and neutralize the contaminated air. For instance, chlorine is removed by reaction with sodium thiosulfate and phosgene is removed by reaction with hexamethyltetramine.

As would be appreciated by a person having ordinary skill in the art, filters exist for filtering many types of contaminated air, such as air contaminated by, for example, smoke, particulate matter, toxic gases, hydrogen cyanide, hydrogen chloride, carbon monoxide and biological and chemical weapons. As a result, a user does not have to be concerned with the type of filter included in the respirator, as the filter is operable to filter a variety of types of contaminated air.

In addition to a filter or in place thereof, a respirator can include an oxygen tank providing a closed system for the user to breathe within. An example of such a self-contained breathing apparatus system is the system a firefighter uses which includes a full-face mask with an air tank on his or her back.

A need exist, however, for a compact breathing apparatus that can easily be carried and used by a user and is operable to filter a plurality of contaminates. A need also exist for the breathing apparatus to include a removably attached nose clip and/or a removably attached transparent bag to protect the user's eyes, ears and nose from the contaminates. Further, there is a need for a compact breathing apparatus that includes an air source, such as an oxygen unit, and a removably attached nose clip and/or removably attached transparent bag.

### SUMMARY OF THE INVENTION

An aspect of the present application provides for a breathing apparatus. The breathing apparatus includes a filtering unit, the filtering unit including an inlet for receiving contaminated air and at least one filter for converting the contaminated air to purified air, a chamber having an opening, the chamber coupled to the filtering unit for collecting the purified air, a mouthpiece coupled to the chamber, the mouthpiece operable for resting in the mouth of a user so that the user can inhale the purified air through the opening and exhale carbon dioxide through the opening without the use of hands, an outlet coupled to the chamber for releasing the exhaled carbon dioxide, and a nose plug removably attached to at least one of the chamber and the filtering unit, the nose plug operable for closing nasal passages of the user.

Another aspect of the present application provides for a breathing apparatus including a filtering unit, the filtering unit including an inlet for receiving contaminated air and at least one filter for converting the contaminated air to purified air, a chamber having an opening, the chamber coupled to the filtering unit for collecting the purified air, a mouthpiece coupled to the chamber, the mouthpiece operable for resting in the mouth of a user so that the user can inhale the purified air through the opening and exhale carbon dioxide through the opening without the use of hands, an outlet coupled to the chamber for releasing the exhaled carbon dioxide, a nose plug removably attached to at least one of the chamber and the filtering unit, the nose plug operable for closing nasal passages of the user, and a transparent bag removably attached to at least one of the nose plug, the chamber and the mouthpiece, the transparent bag operable for preventing contaminated air from entering the eyes, ears and nose of the user when placed over the head of the user.

A further aspect of the present application provides for a breathing apparatus. The breathing apparatus includes a filtering unit, the filtering unit including an inlet for receiving contaminated air and at least one filter for converting the contaminated air to purified air, a chamber having an opening, the chamber coupled to the filtering unit for collecting the purified air, a mouthpiece coupled to the chamber, the mouthpiece operable for resting in the mouth of a user so that the user can inhale the purified air through the opening and exhale carbon dioxide through the opening without the use of hands, an outlet coupled to the chamber for releasing exhaled carbon dioxide, a nose plug removably attached to at least one of the chamber and the filtering unit, the nose plug operable for closing nasal passages of the user, a transparent bag removably attached to at least one of the nose plug, the chamber and the mouthpiece, the transparent bag operable for preventing contaminated air from entering the eyes, ears and nose of the user when placed over the head of the user, and a clip attached to the filtering unit, the clip operable for fastening the filtering unit to an article.

A still further aspect of the present application provides for a breathing apparatus, including a filtering unit, a chamber coupled to the filtering unit, a mouthpiece coupled to the chamber, an outlet coupled to the chamber, a nose clip and a transparent bag when assembled, and the filtering unit, the chamber coupled to the filtering unit, the mouthpiece coupled to the chamber and the outlet coupled to the chamber when disassembled.

Another aspect of the present application provides for a breathing apparatus. The breathing apparatus includes an air source for storing air, an outlet coupled to the air source, the outlet operable for releasing the air stored in the air source for inhalation by a user, a filtering unit having an opening, the filtering unit coupled to the outlet, the filtering unit including at least one filter for filtering exhaled carbon dioxide when the user inhales, a mouthpiece coupled to the filtering unit, the mouthpiece operable for resting in the mouth of a user so that the user can inhale air through the opening and exhale the carbon dioxide through the opening without the use of hands, an expandable sac coupled to the filtering unit for collecting the carbon dioxide exhaled by the user, and a nose plug removably attached to at least one of the filtering unit and the air source, the nose plug operable for closing nasal passages of the user.

A further aspect of the present application provides for a breathing apparatus, including an oxygen unit for storing oxygen, an outlet coupled to the oxygen unit, the outlet operable for releasing the oxygen stored in the oxygen unit for inhalation by a user, a filtering unit having an opening, the filtering unit coupled to the outlet, the filtering unit including at least one filter comprised of carbon for filtering exhaled carbon dioxide when the user inhales, a mouthpiece coupled to the filtering unit, the mouthpiece operable for resting in the mouth of a user so that the user can inhale the oxygen through the opening and exhale the carbon dioxide though the opening without the use of hands, an expandable sac coupled to the filtering unit for collecting the carbon dioxide exhaled by the user, a nose plug removably attached to at least one of the filtering unit and the oxygen unit, the nose plug operable for closing nasal passages of the user, and a transparent bag removably attached to at least one of the filtering unit and the mouthpiece, the transparent bag operable for preventing contaminated air from entering the eyes, ears and nose of the user when the transparent bag is placed over the head of the user.

A still further aspect of the present application provides for a breathing apparatus. The breathing apparatus includes an oxygen unit for storing oxygen, an outlet coupled to the oxygen unit, the outlet operable for releasing the oxygen stored in the oxygen unit for inhalation by a user, a filtering unit having an opening, the filtering unit coupled to the outlet, the filtering unit including at least one filter comprised of carbon for filtering exhaled carbon dioxide when the user inhales, a mouthpiece coupled to the filtering unit, the mouthpiece operable for resting in the mouth of a user so that the user can inhale the oxygen through the opening and exhale the carbon dioxide through the opening without the use of hands, an expandable sac coupled to the filtering unit for collecting the carbon dioxide exhaled by the user, a nose plug removably attached to at least one of the filtering unit and the oxygen unit, the nose plug operable for closing nasal passages of the user, a transparent bag removably attached to at least one of the filtering unit and the mouthpiece, the transparent bag operable for preventing contaminated air from entering the eyes, ears and nose of the user when the transparent bag is placed over the head of the user, and a clip attached to the filtering unit, the clip operable for fastening the filtering unit to an article.

An additional aspect of the present application provides for a breathing apparatus, including an air source, an outlet coupled to the air source, a filtering unit coupled to the outlet, a mouthpiece coupled to the filtering unit, an expandable sac coupled to the filtering unit, a nose clip and a transparent bag when assembled, and the air source, the outlet coupled to the air source, the filtering unit coupled to the outlet, the mouthpiece coupled to the filtering unit and the expandable sac coupled to the filtering unit when disassembled.

An aspect of the present application provides for a method for inhaling purified air. The method includes removing a nose clip of a breathing apparatus, placing the nose clip on a nose of a user, the nose clip operable for blocking nasal passages of the nose, and placing a mouthpiece of the breathing apparatus in the mouth, the mouthpiece operable for the user to inhale the purified air filtered by a filtering unit of the breathing apparatus.

Another aspect of the present application provides for a method for inhaling purified air. The method includes removing a nose clip of a breathing apparatus, placing the nose clip on a nose of a user, the nose clip operable for blocking nasal passages of the nose, removing a transparent bag of the breathing apparatus, placing the transparent bag on a head of the user, the transparent bag operable for preventing contaminated air from entering the nose, a mouth and ears of the user, and placing a mouthpiece of the breathing apparatus in the mouth, the mouthpiece operable for the user to inhale the purified air filtered by a filtering unit of the breathing apparatus.

A further aspect of the present application provides for a method for preventing inhalation of contaminated air, the method including removing a nose clip of a breathing apparatus, placing the nose clip on a nose of a user, the nose clip operable for blocking nasal passages of the nose, and placing a mouthpiece of the breathing apparatus in the mouth, the mouthpiece operable for the user to inhale oxygen from an oxygen unit of the breathing apparatus.

A still further aspect of the present application provides for a method for preventing inhalation of contaminated air. The method includes removing a nose clip of a breathing apparatus, placing the nose clip on a nose of a user, the nose clip operable for blocking nasal passages of the nose, removing a transparent bag of the breathing apparatus, placing the transparent bag on a head of the user, the transparent bag operable for preventing contaminated air from entering the nose, a mouth and ears of the user, and placing a mouthpiece of the breathing apparatus in the mouth, the mouthpiece operable for the user to inhale oxygen from an oxygen unit of the breathing apparatus.

### BRIEF DESCRIPTION OF THE DRAWINGS

FIG. 1 illustrates a disassembled exemplary breathing apparatus;

FIG. 2 illustrates the assembled exemplary breathing apparatus shown in FIG. 1 being carried by an individual;

FIG. 3 illustrates an individual using the exemplary breathing apparatus shown in FIGS. 1 and 2;

FIG. 4 illustrates another disassembled exemplary breathing apparatus;

FIG. 5 illustrates the assembled exemplary breathing apparatus shown in FIG. 4 being carried by an individual;

FIG. 6 illustrates an individual using the exemplary breathing apparatus shown in FIGS. 4 and 5;

FIG. 7a illustrates the rotation of a clip of an exemplary breathing; and

FIG. 7b illustrates an individual using the clip of the exemplary breathing apparatus as a whistle.

### DETAILED DESCRIPTION

The exemplary embodiments of the present application comprise various breathing apparatuses that enable an individual using the respective breathing apparatus to breathe non-contaminated air or air that is at least less harmful to breathe than the contaminated air. Air can be contaminated by, for example, smoke, particulate matter, toxic gases, hydrogen cyanide, hydrogen chloride, carbon monoxide and biological and chemical weapons. The exemplary breathing apparatuses of the present application are operable to prevent or reduce inhalation of such contaminated air by an individual. Further, the exemplary breathing apparatuses prevent contaminated air from entering the nose, eyes and ears of the user by covering these openings with a transparent bag. The breathing apparatuses of the present application can be used by adults and children.

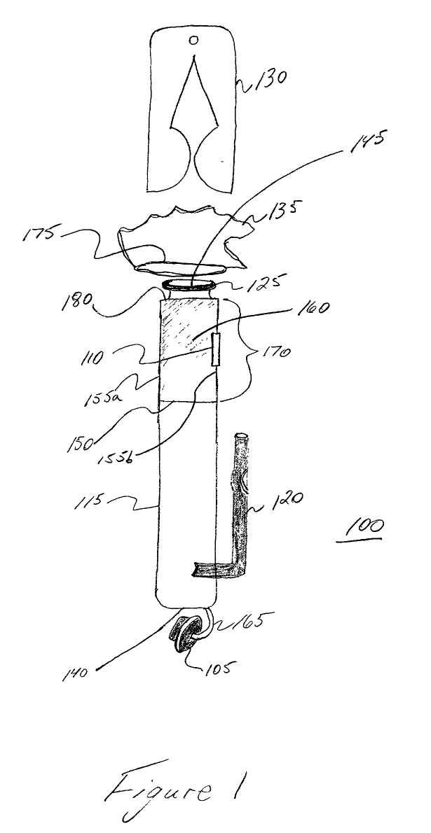

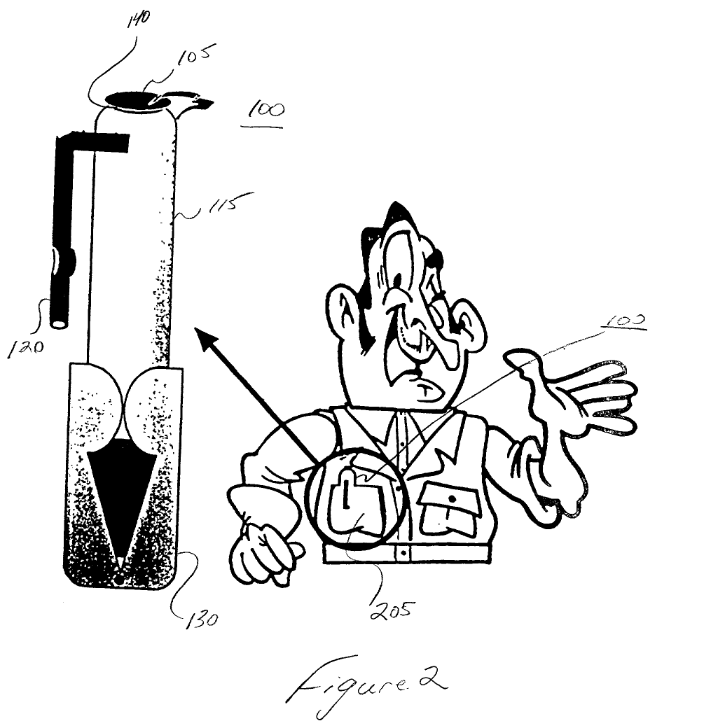

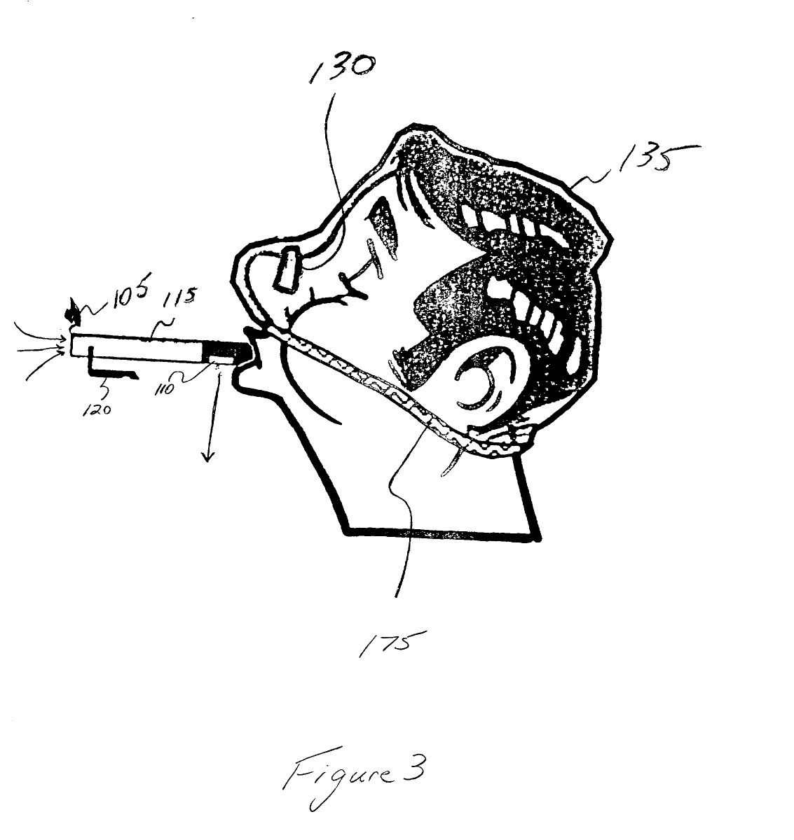

FIGS. 1, 2 and 3 illustrate exemplary breathing apparatus 100 of the present application. FIG. 1 depicts breathing apparatus 100 disassembled and not is use, FIG. 2 shows breathing apparatus 100 assembled and placed in shirt pocket 205 of the individual ready to be used, and FIG. 3 shows breathing apparatus 100 disassembled and being used by an individual.

Breathing apparatus 100 shown in FIG. 1 includes filtering unit 115 having inlet 140 that can be covered by inlet cover 105, inlet cover 105 being attached to filtering unit 115 by strap 165. Filtering unit 115 is coupled to chamber 170. Chamber 170 is comprised of top wall 180 having opening 145, bottom wall 150 having an opening not shown in the drawings and side walls 155a, 155b. Cavity 160 is located in chamber 170, carbon dioxide outlet 110 is coupled to side wall 155b and mouthpiece 145 is coupled to top wall 180. Further, breathing apparatus 100 includes nose clip 130 and bag 135 which are removably attached to one or more other components of breathing apparatus 100 and clip 120 coupled to filtering unit 115. FIG. 2 illustrates nose clip 130 being removably attached to chamber 170 and filtering unit 115. Bag 135 can be stored, for example, inside mouthpiece 125 or removably attached to nose clip 130, chamber 170 or filtering unit 115.

Upon a user inhaling through mouthpiece 125 when output cover 105 is opened, the contaminated air enters inlet 140, is filtered by filtering unit 115 and travels though an opening between filtering unit 115 and chamber 170 into cavity 160. The filtered air exits chamber 170 through opening 145. As can be seen in FIG. 1, opening 145 is located in mouthpiece 125. The use of filters to filter numerous types of contaminated air are well known in the art and, therefore, are not described herein. Carbon dioxide exhaled by the user enters chamber 170 through opening 145 and exits chamber 170 through carbon dioxide outlet 110. Outlet 110 is operable for only allowing air to exit chamber 170. The shapes and sizes of the components of breathing apparatus 100 are merely illustrative.

In order to use breathing apparatus 100 to filter contaminated air, breathing apparatus 100 has to be disassembled as shown in FIG. 1. Breathing apparatus 100 is disassembled by disengaging nose clip 130, for example, from chamber 170 and/or filtering unit 115, by removing inlet cover 105 so that the contaminated air can enter filtering unit 115 through inlet 140 and by removing bag 135.

FIG. 3 illustrates an individual using exemplary breathing apparatus 100 to filter contaminated air. As can be seen in FIG. 3, the individual uses breathing apparatus 100 by grasping at least mouthpiece 145 with the individual's mouth. Due to at least the light weight of breathing apparatus 100, the user's hands are not needed to hold breathing apparatus 100 in place and are, thus, free to attend to other needs. In addition, the user places nose clip 130 over his or her nose to prevent the contaminated air from entering the user's nose.

Besides using nose clip 130, transparent bag 135 is placed over the user's head, as shown in FIG. 3. In an exemplary embodiment, bag 135 is made of a material that is at least lightweight, flexible, fire resistant, fog resistant or impermeable to air contaminated by, for example, smoke, particulate matter, toxic gases, hydrogen cyanide, hydrogen chloride, carbon monoxide and biological and chemical weapons. An example of such material is a multi-layered copolymer, polyethylene material sold by Plastopil, Kibbutz Hazorea 30060, Israel. Other materials can obviously be used for bag 135. Bag 135 shown in FIGS. 1 and 3 is completely transparent. In an alternative embodiment, however, only a portion of bag 135 is transparent so that the user can only see out of that portion of bag 135 when in use. When the entire bag 135 is transparent, bag 135 can be placed over a head without concern of whether a transparent portion is located in the proper place for visibility. Since bag 135 is made of a lightweight and flexible material, bag 135 can easily conform to any head shape and size. Also, bag 135 prevents contaminated air from entering the nose, eyes and ears of the user, as bag 135 covers these openings and is secured around the head of the user by, for instance, elastic band 175. Moreover, bag 135 protects a user's hair from catching fire. Bag 135 is not limited to any particular size or shape. Ideally, bag 135 has a size that is appropriate for numerous types of users, such as adults and children.

Alternatively, the individual can use bag 135 without nose clip 130 or only nose clip 130 can be used. Bag 135 can be removably attached to mouthpiece 125 and/or filtering unit 115. Further, bag 135 can be stored within breathing apparatus 100, for example, within mouthpiece 125, so that bag 135 can be easily and quickly removed and used by the individual upon detaching nose clip 130.

FIG. 2 illustrates breathing apparatus 100 assembled. When breathing apparatus 100 is assembled, inlet cover 105 is engaged with filtering unit 115 so as to cover inlet 145, bag 135 is removably attached to mouthpiece 125, for instance, by being stored therein, and nose clip 130 is fastened onto chamber 170 and/or filtering unit 115. The manner of removably attaching nose clip 130 and bag 135 and the location of nose clip 130 and bag 135 as described herein is merely exemplary.

The assembled breathing apparatus 100 can be attached to an individual's pocket 205 by using clip 120, as shown in FIG. 2. Besides using clip 120 to attach breathing apparatus 100 to an article, clip 120 is operable as a whistle to attract attention, for example, of a rescuer. In an alternative embodiment, clip 120 is only operable for fastening purposes. In a further alternative embodiment, breathing apparatus 100 does not include clip 120. The size, shape and style of clip 120 shown in FIGS. 1, 2 and 3 are merely exemplary.

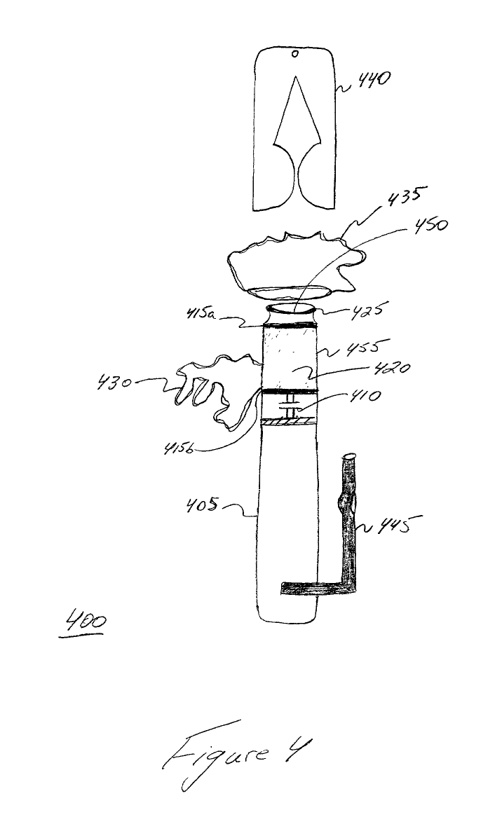

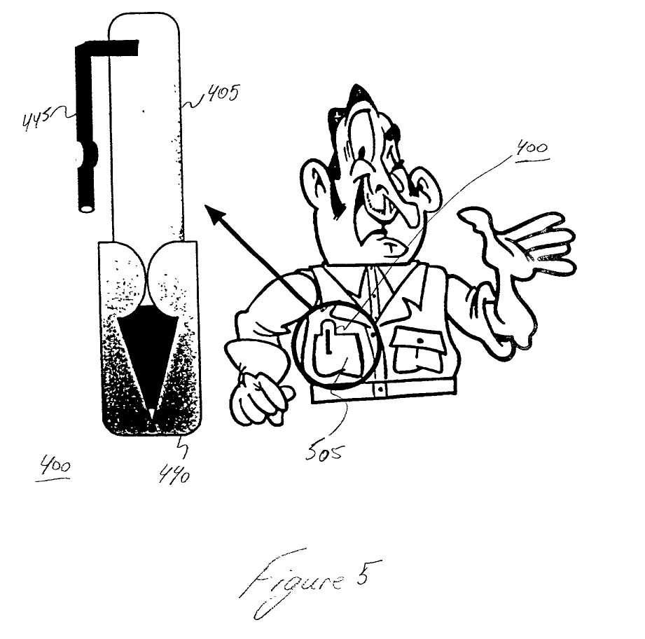

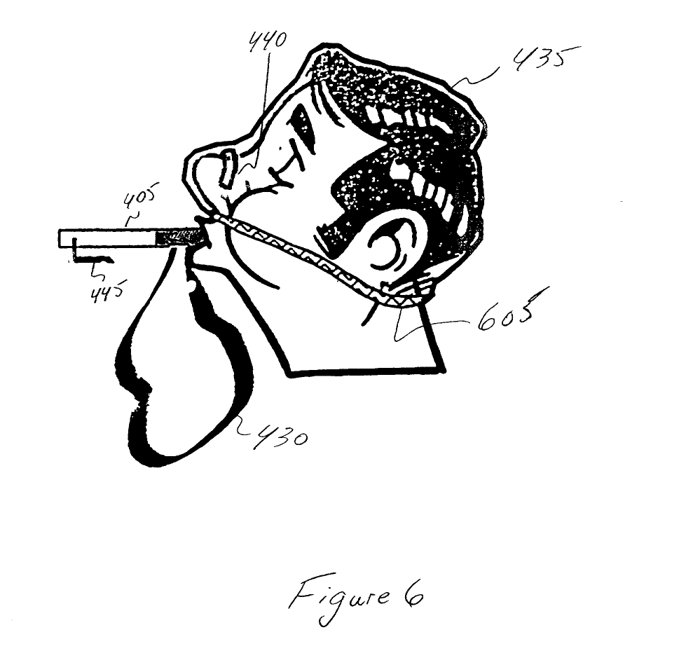

FIGS. 4, 5 and 6 illustrate another exemplary breathing apparatus 400 of the present application. FIG. 4 depicts breathing apparatus 400 disassembled and not is use, FIG. 5 shows breathing apparatus 400 assembled and placed in shirt pocket 505 of the individual ready to be used and FIG. 6 shows breathing apparatus 400 disassembled and being used by the individual.

Breathing apparatus 400 includes air source 405, for instance, an oxygen unit for storing oxygen, outlet 410 coupled to oxygen unit 405 for releasing the stored oxygen, filtering unit 455 including at least one filtering layer, sac 430 attached to filtering unit 455 for storing at least exhaled carbon dioxide, mouthpiece 425 coupled to filtering unit 455, clip 445 coupled to oxygen unit 405 for securing breathing apparatus 400 to an article, and nose clip 440 and bag 435 which are removably attached to, for example, filtering unit 455. The shapes and sizes of the components of breathing apparatus 400 are merely illustrative.

Since breathing apparatus 400 creates a closed system when in use, the user is protected from the contaminated air. The oxygen stored in oxygen unit 405 exits at opening 410 and is inhaled by the user through opening 450 located within mouthpiece 425 and carbon dioxide exhaled by the user passes through opening 450 and is stored in sac 430. Filtering unit 455 includes filtering layer 420 for filtering at least the carbon dioxide and filtering layers 415a, 415b. In an exemplary embodiment, filtering layer 420 includes carbon and filtering layers 415a, 415b are operable to keep the carbon in filtering unit 455, for instance, so the user does not inhale the carbon when using breathing apparatus 400. An example of the carbon that can used between filtering layers 415a, 415b is WSL 4-8 REG HP from DAREX Container Products, 55 Hayden Avenue, Lexington, Mass. 02421. Instead of using sac 430 to store carbon dioxide, carbon dioxide exhaled by the individual can exit breathing apparatus 400 through a carbon dioxide outlet, not shown in the drawings.

In order to use breathing apparatus 400, breathing apparatus 400 has to be disassembled as shown in FIG. 4. Breathing apparatus 400 is disassembled by removing nose clip 440 from mouthpiece 425 and/or filtering unit 455 and by removing bag 435 located, for instance, within mouthpiece 425. In an exemplary embodiment, oxygen begins to flow through opening 410 from oxygen unit 405 when a valve, not shown in the drawings, is turned. For instance, a user may turn the valve by turning oxygen unit 405 while holding stationary the remainder of breathing apparatus 400. Other methods for releasing oxygen from oxygen unit 405 can also be incorporated into breathing apparatus 400, either in place of the valve or in conjunction therewith.

FIG. 6 illustrates an individual using the exemplary breathing apparatus 400 to breathe oxygen from oxygen unit 405. As can be seen in FIG. 6, the individual uses breathing apparatus 400 by grasping at least mouthpiece 425 with the individual's mouth. Due to at least the dimensions and light weight of breathing apparatus 400, the user's hands are not needed to hold breathing apparatus 400 in place and are, thus, free to attend to other needs. In addition, the user places nose clip 440 over his or her nose to prevent the contaminated air from entering the user's nose.

In addition to using nose clip 440, bag 435 can be placed over the individual's head, as shown in FIG. 6. In an exemplary embodiment, bag 435 is made of a material that is at least lightweight, flexible, fire resistant, fog resistant or impermeable to air contaminated by, for example, smoke, particulate matter, toxic gases, hydrogen cyanide, hydrogen chloride, carbon monoxide and biological and chemical weapons. An example of such material is a multi-layered copolymer, polyethylene material sold by Plastopil, Kibbutz Hazorea 30060, Israel. Other materials can obviously be used for bag 435. Sac 430 is also made of such a material, as sac 430 will be in contact with the contaminated air and exposed to the same conditions as bag 435. Bag 435 shown in FIGS. 4 and 6 is completely transparent. In an alternative embodiment, however, only a portion of bag 435 is transparent so that user can only see out of that portion of bag 435 when in use. When the entire bag 435 is transparent, bag 435 can be placed over a head without concern of whether a transparent portion is located in the proper place for visibility. Since bag 435 is made of a lightweight and flexible material, bag 435 can easily conform to any head shape and size. Also, bag 435 prevents contaminated air from entering the nose, eyes and ears of the user, as bag 435 covers these openings and is secured around the head of the user by, for instance, elastic band 605. Moreover, bag 435 protects an individual's hair from catching fire. Bag 435 is not limited to any particular size or shape. Ideally, bag 435 has a size that is appropriate for numerous types of users, such as adults and children.

Alternatively, the individual can use bag 435 without nose clip 440 or only nose clip 440 can be used. Bag 435 can be removably attached to filtering unit 455 or oxygen unit 405, as with bag 135 described above. Further, bag 435 can be stored within breathing apparatus 400, for example, within mouthpiece 425, so that bag 435 can be easily and quickly removed and used by the individual after nose clip 440 is detached.

FIG. 5 illustrates breathing apparatus 400 assembled. When breathing apparatus 400 is assembled, bag 435 is removably attached to mouthpiece 425 and/or filtering unit 455, or stored within breathing apparatus 400, and nose clip 440 is fastened onto filtering unit 455 and/or oxygen unit 405. In addition, sac 430 is secured under nose clip 440. The assembled breathing apparatus 400 can be attached to an individual's pocket 505 by using clip 455, as shown in FIG. 5. Besides using clip 455 to attach breathing apparatus 400 to an article, clip 455 is operable as a whistle. In an alternative embodiment, clip 455 is only operable for fastening purposes. In a further alternative embodiment, breathing apparatus 400 does not include clip 455. The size, shape and style of clip 455 shown in FIGS. 4, 5 and 6 is merely exemplary. In addition, clip 445, and clip 120, can be permanently affixed to oxygen unit 405 and filtering unit 115, respectively, or can removably attached thereto.

In an exemplary embodiment, filtering unit 455, filtering unit 115 and oxygen unit 405 are replaceable, for example, when the filtering layers are no longer operative, different types of filtering layers are desired or oxygen unit 405 is low or empty. Alternatively, breathing device 400 and breathing device 100 can be operable for only a single use. The use time of breathing device 400 is at least dependent on the capacity of oxygen unit 405 and the rate of discharge of the oxygen from oxygen unit 405. Further, the use time of breathing apparatus 400 and breathing apparatus 100 are at least dependent on characteristics of the filters used, as is well known to a person of ordinary skill in the art. For example, a filter may only filter air contaminated by a particular gas for twenty to thirty minutes due to the filter getting clogged with the filtered gas.

Exemplary breathing apparatus 400 described in the present application that uses an air source, such as oxygen unit 405, can be stored in a vacuum sealed bag in order to notify a potential user that some air has leaked from the source during storage. Specifically, the bag or a portion thereof will expand due to the leaking air and as a result put the user or another person on notice that some, if not all, of the air has leaked. Other leaking indicators can be used besides viewing the expansion of a storage bag, such as a change in coloration of the bag or a portion thereof.

As can be seen in FIGS. 1 through 6, breathing apparatus 100 and breathing apparatus 400 have a pen-like shape. Accordingly, breathing apparatus 100, 400 are aesthetically pleasing when placed, for instance, in a shirt pocket. Breathing apparatus 100, 400 can assume other shapes regardless of their aesthetic value.

Further, when exemplary breathing apparatus 100 and exemplary breathing apparatus 400 are assembled as described above with reference to FIGS. 2 and 5, respectively, breathing apparatuses 100, 400 are compact and lightweight, and, thus, easy to carry at all times.

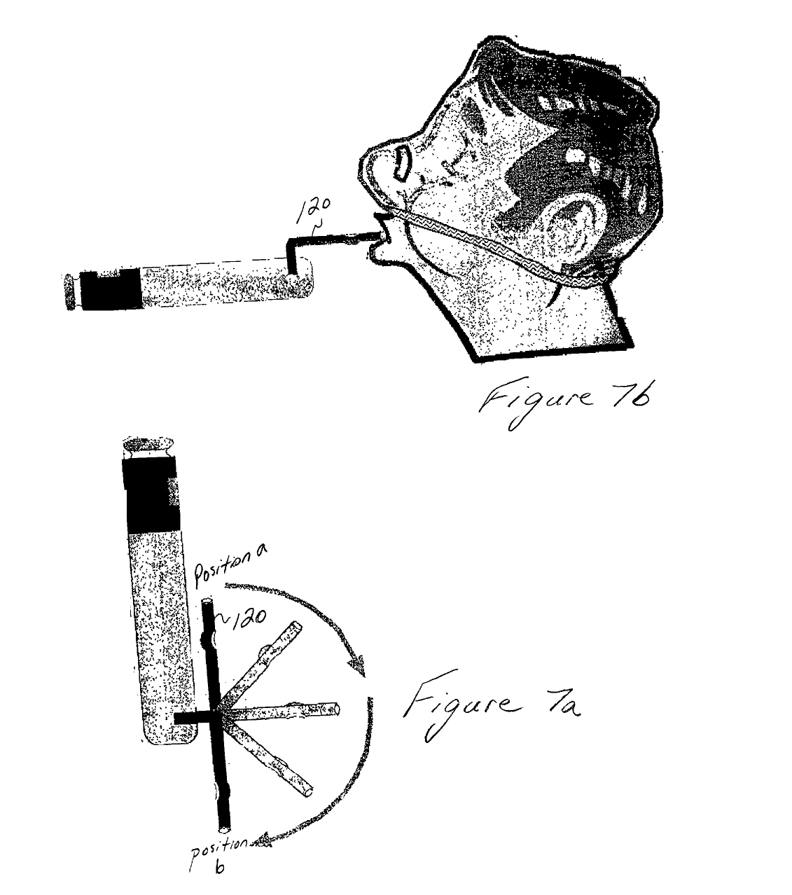

FIGS. 7a and 7b illustrate the rotation of clip 120 of exemplary breathing 100 when clip 120 is operable as a whistle and an individual using clip 120 as a whistle, respectively. Specifically, FIG. 7a shows clip 120 operable so that is can be rotated from position a to position b. Clip 120 remains in a locked state when in position a and position b so that clip 120 can be used as a clip or as a whistle, respectively. A relatively small degree of force is needed to disengage clip 120 from a locked position. Clip 445 of breathing apparatus 400 operates in the same manner as clip 120 and, thus, is not described herein. When an individual desires to use clip 120, or clip 445, as a whistle, the individual rotates clip 120 to position b. Once in position b, clip 120 can be used as a whistle, as depicted in FIG. 7b. Clips 120 and 445 may or may not be rotatable if the clips are not operable as whistles. Further, clips 120 and 445 can be configured so that the clips 120, 445 do not need to be rotated in order to be used, as the shape, size and movement shown in FIGS. 7a and 7b are merely illustrative.

The embodiments described above are illustrative examples of the present invention and it should not be construed that the present invention is limited to these particular embodiments. Various changes and modifications may be effected by one skilled in the art without departing from the spirit or scope of the invention as defined in the appended claims. Accordingly, the present invention is not limited except as by the appended claims.

I claim:

1. A breathing apparatus, comprising:
a filtering unit, the filtering unit including an inlet for receiving contaminated air and at least one filter for converting the contaminated air to purified air;
a chamber having an opening, the chamber coupled to the filtering unit for collecting the purified air;
a mouthpiece coupled to the chamber, the mouthpiece operable for resting in the mouth of a user so that the user can inhale the purified air through the opening and exhale carbon dioxide through the opening without the use of hands;
an outlet coupled to the chamber for releasing the exhaled carbon dioxide; and
a nose plug removably attached to at least one of the chamber and the filtering unit, the nose plug operable for closing nasal passages of the user.

2. The breathing apparatus as set forth in claim 1, further comprising:
a transparent bag removably attached to at least one of the nose plug, the chamber and the mouthpiece, the transparent bag operable for preventing contaminated air from entering the eyes, ears and nose of the user when placed over the head of the user.

3. The breathing apparatus as set forth in claim 1, further comprising:
a clip attached to the filtering unit, the clip operable as a whistle and operable for fastening the filtering unit to an article.

4. The breathing apparatus as set forth in claim 1, further comprising:
a clip attached to the filtering unit, the clip operable for fastening the filtering unit to an article.

5. The breathing apparatus as set forth in claim 1, wherein the filtering unit is elongated.

6. The breathing apparatus as set forth in claim 1, wherein the filtering unit, the chamber, the mouthpiece and the nose plug when assembled have a pen-like configuration.

7. A breathing apparatus, comprising:
a filtering unit, the filtering unit including an inlet for receiving contaminated air and at least one filter for converting the contaminated air to purified air;
a chamber having an opening, the chamber coupled to the filtering unit for collecting the purified air;
a mouthpiece coupled to the chamber, the mouthpiece operable for resting in the mouth of a user so that the user can inhale the purified air through the opening and exhale carbon dioxide through the opening without the use of hands;
an outlet coupled to the chamber for releasing the exhaled carbon dioxide;
a nose plug removably attached to at least one of the chamber and the filtering unit, the nose plug operable for closing nasal passages of the user; and
a transparent bag removably attached to at least one of the nose plug, the chamber and the mouthpiece, the transparent bag operable for preventing contaminated air from entering the eyes, ears and nose of the user when placed over the head of the user.

8. A breathing apparatus, comprising:
a filtering unit, the filtering unit including an inlet for receiving contaminated air and at least one filter for converting the contaminated air to purified air;
a chamber having an opening, the chamber coupled to the filtering unit for collecting the purified air;
a mouthpiece coupled to the chamber, the mouthpiece operable for resting in the mouth of a user so that the user can inhale the purified air through the opening and exhale carbon dioxide through the opening without the use of hands;
an outlet coupled to the chamber for releasing exhaled carbon dioxide;
a nose plug removably attached to at least one of the chamber and the filtering unit, the nose plug operable for closing nasal passages of the user;
a transparent bag removably attached to at least one of the nose plug, the chamber and the mouthpiece, the transparent bag operable for preventing contaminated air from entering the eyes, ears and nose of the user when placed over the head of the user; and
a clip attached to the filtering unit, the clip operable for fastening the filtering unit to an article.

9. A breathing apparatus, comprising:
a filtering unit, a chamber coupled to the filtering unit, a mouthpiece coupled to the chamber, an outlet coupled to the chamber, a nose clip and a transparent bag when assembled; and
the filtering unit, the chamber coupled to the filtering unit, the mouthpiece coupled to the chamber and the outlet coupled to the chamber when disassembled.

10. A breathing apparatus, comprising:
an air source for storing air;
an outlet coupled to the air source, the outlet operable for releasing the air stored in the air source for inhalation by a user;
a filtering unit having an opening, the filtering unit coupled to the outlet, the filtering unit including at least one filter for filtering exhaled carbon dioxide when the user inhales;
a mouthpiece coupled to the filtering unit, the mouthpiece operable for resting in the mouth of a user so that the user can inhale air through the opening and exhale the carbon dioxide through the opening without the use of hands;
an expandable sac coupled to the filtering unit for collecting the carbon dioxide exhaled by the user; and
a nose plug removably attached to at least one of the filtering unit and the air source, the nose plug operable for closing nasal passages of the user.

11. The breathing apparatus as set forth in claim 10, further comprising:
a transparent bag removably attached to at least one of the filtering unit and the mouthpiece, the transparent bag operable for preventing contaminated air from entering the eyes, ears and nose of the user when the transparent bag is placed over the head of the user.

12. The breathing apparatus as set forth in claim 10, further comprising:
a clip attached to the filtering unit, the clip operable as a whistle and operable for fastening the filtering unit to an article.

13. The breathing apparatus as set forth in claim 10, further comprising:
a clip attached to the filtering unit, the clip operable for fastening the filtering unit to an article.

14. The breathing apparatus as set forth in claim 10, wherein
the at least one filter is comprised of carbon.

15. The breathing apparatus as set forth in claim 10, wherein
the air source is an oxygen unit.

16. A breathing apparatus, comprising:
an oxygen unit for storing oxygen;
an outlet coupled to the oxygen unit, the outlet operable for releasing the oxygen stored in the oxygen unit for inhalation by a user;
a filtering unit having an opening, the filtering unit coupled to the outlet, the filtering unit including at least one filter comprised of carbon for filtering exhaled carbon dioxide when the user inhales;
a mouthpiece coupled to the filtering unit, the mouthpiece operable for resting in the mouth of a user so that the user can inhale the oxygen through the opening and exhale the carbon dioxide though the opening without the use of hands;
an expandable sac coupled to the filtering unit for collecting the carbon dioxide exhaled by the user;
a nose plug removably attached to at least one of the filtering unit and the oxygen unit, the nose plug operable for closing nasal passages of the user; and
a transparent bag removably attached to at least one of the filtering unit and the mouthpiece, the transparent bag operable for preventing contaminated air from entering the eyes, ears and nose of the user when the transparent bag is placed over the head of the user.

17. A breathing apparatus, comprising:
an oxygen unit for storing oxygen;
an outlet coupled to the oxygen unit, the outlet operable for releasing the oxygen stored in the oxygen unit for inhalation by a user;
a filtering unit having an opening, the filtering unit coupled to the outlet, the filtering unit including at least one filter comprised of carbon for filtering exhaled carbon dioxide when the user inhales;
a mouthpiece coupled to the filtering unit, the mouthpiece operable for resting in the mouth of a user so that the user can inhale the oxygen through the opening and exhale the carbon dioxide through the opening without the use of hands;
an expandable sac coupled to the filtering unit for collecting the carbon dioxide exhaled by the user;
a nose plug removably attached to at least one of the filtering unit and the oxygen unit, the nose plug operable for closing nasal passages of the user;
a transparent bag removably attached to at least one of the filtering unit and the mouthpiece, the transparent bag operable for preventing contaminated air from entering the eyes, ears and nose of the user when the transparent bag is placed over the head of the user; and
a clip attached to the filtering unit, the clip operable for fastening the filtering unit to an article.

18. A breathing apparatus, comprising:
an air source, an outlet coupled to the air source, a filtering unit coupled to the outlet, a mouthpiece coupled to the filtering unit, an expandable sac coupled to the filtering unit, a nose clip and a transparent bag when assembled; and
the air source, the outlet coupled to the air source, the filtering unit coupled to the outlet, the mouthpiece coupled to the filtering unit and the expandable sac coupled to the filtering unit when disassembled.

19. A method for inhaling purified air, the method comprising:
removing a nose clip of a breathing apparatus;
placing the nose clip on a nose of a user, the nose clip operable for blocking nasal passages of the nose; and
placing a mouthpiece of the breathing apparatus in the mouth, the mouthpiece operable for the user to inhale the purified air filtered by a filtering unit of the breathing apparatus.

20. A method for inhaling purified air, the method comprising:
removing a nose clip of a breathing apparatus;
placing the nose clip on a nose of a user, the nose clip operable for blocking nasal passages of the nose;
removing a transparent bag of the breathing apparatus;
placing the transparent bag on a head of the user, the transparent bag operable for preventing contaminated air from entering the nose, a mouth and ears of the user; and
placing a mouthpiece of the breathing apparatus in the mouth, the mouthpiece operable for the user to inhale the purified air filtered by a filtering unit of the breathing apparatus.

21. A method for preventing inhalation of contaminated air, the method comprising:
removing a nose clip of a breathing apparatus;
placing the nose clip on a nose of a user, the nose clip operable for blocking nasal passages of the nose; and
placing a mouthpiece of the breathing apparatus in the mouth, the mouthpiece operable for the user to inhale oxygen from an oxygen unit of the breathing apparatus.

22. A method for preventing inhalation of contaminated air, the method comprising:
removing a nose clip of a breathing apparatus;
placing the nose clip on a nose of a user, the nose clip operable for blocking nasal passages of the nose;
removing a transparent bag of the breathing apparatus;
placing the transparent bag on a head of the user, the transparent bag operable for preventing contaminated air from entering the nose, a mouth and ears of the user; and
placing a mouthpiece of the breathing apparatus in the mouth, the mouthpiece operable for the user to inhale oxygen from an oxygen unit of the breathing apparatus.
